(19) United States
(12) Patent Application Publication
(10) Pub. No.: US 2005/0259750 A1
(43) Pub. Date: Nov. 24, 2005

(54) Method and encoder for encoding a digital video signal

(75) Inventor: Gwenaelle Marquant, Liffre (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Enindhoven (NL)

(21) Appl. No.: 10/521,709

(22) PCT Filed: Jul. 8, 2003
(86) PCT No.: PCT/IB03/03012

§ 371 Date: Jan. 19, 2005

(30) Foreign Application Priority Data
Jul. 24, 2002 (EP) 02291872.6

(51) Int. Cl. H04N 11/04

(52) U.S. Cl. 375/240.26

(57) ABSTRACT

The present invention relates to a method and an encoder for processing a digital video signal, said digital video signal comprising at least a scene cut (CUT) followed by a set of images. It is characterized in that it comprises the steps of:—Localizing said scene cut (CUT),—Defining a sub set of visually non-relevant images (IS) within said set of images, and—Issuing a set of encoded visually non-relevant images (IS′) just after the scene cut (CUT) by calculating said set from a visually relevant image (I(to+2)) after said scene cut (CUT).

### FIELD OF THE INVENTION

The present invention relates to a method for encoding a digital video signal, said digital video signal comprising at least a scene cut followed by a set of images. The invention also relates to an encoder, said encoder implementing said method.

Such a method may for example be used in a video communication system.

### BACKGROUND OF THE INVENTION

A video communication system, like for example a television communication system, typically comprises an encoder, a transmission medium and a decoder. Such a system receives an input digital video signal, encodes said signal thanks to the encoder, transmits the encoded signal, also called bit stream, via the transmission medium, then decodes or reconstructs the transmitted signal thanks to the decoder, resulting in an output digital video signal. Most of the time, a digital video signal comprises at least a scene cut followed by a set of images.

Each image of the digital video signal is encoded along different schemes: either in an intraframe model, that is independently from other images or in an interframe one, that is differentially from a motion compensation of a previous or following image of the digital video signal. An image, which is encoded using an intraframe model is called an intra frame. An image, which is encoded using an interframe model is called an inter frame. An intra frame has a higher bit rate cost than an inter frame. Said intra- and interframe models are described in the standard MPEG2 referenced ISO/IEC 13818-2:1996(E), “Information technology—Generic coding of moving pictures and associated audio information: Video”, International standard, 1996.

When a scene cut occurs in an input digital video signal between a previous image and a next image, said previous and next images are generally very different and very low correlated. A consequence is that the next image cannot be encoded efficiently using an interframe model with the previous image. Moreover, encoding the next image using an intraframe model is very costly. In order to take into account the scene cuts, the encoder uses statistics codes, well known to the person skilled in the art, and encodes the images following a scene cut with reference to the statistics codes. At the decoding side, the decoder decodes the images. The scene cuts appear automatically thanks to the previous encoding.

One drawback of this encoding process is that it is difficult to highly improve the rate/distortion ratio whichever encoding scheme is used, the rate/distortion ratio being the ratio of the bit rate used for encoding to the distortion perceived in the decoded image compared with an original image.

### OBJECT AND SUMMARY OF THE INVENTION

Accordingly, it is an object of the invention to provide a method and an encoder for encoding a digital video signal, said digital video signal comprising at least a scene cut followed by a set of images, which allow an improvement of the ratio rate/distortion.

To this end, there is provided a method comprising the steps of:
Localizing said scene cut,
Defining a sub set of visually non-relevant images within said set of images, and
Issuing a set of encoded visually non-relevant images from said sub set of visually non-relevant images by calculating said set of encoded visually non-relevant images from a first visually relevant image located after said scene cut.

In addition, there is provided an encoder comprising:
Localization means for locating said scene cuts,
Definition means for defining a sub set of visually non-relevant images within said set of images, and
Calculation means for issuing a set of encoded visually non-relevant images from said sub set of visually non-relevant images, said set of encoded visually non- relevant images being calculated from a visually relevant image located after said scene cut.

As we will see in detail in the further description, the invention is based on the fact that under standard viewing conditions, human eyes cannot distinguish very fast changes in scenes. This means that the set of images following the scene cut comprises a sub set of images, which are not visible for the human eyes. These images are called visually non-distinguishable or non-relevant images. Next visible image is called a visually distinguishable or relevant image. Therefore, with this principle, the encoding method according to the invention takes into account a visually relevant image to encode the set of visually non-relevant images, which follow a scene cut. Therefore, only the relevant part of information, that is the visually relevant image, is encoded as usual, whereas the non-relevant-part of information, the visually non-relevant images, may be degraded or omitted. In this way, some bit rate is spared. Consequently, the rate/distortion ratio is improved.

Advantageously, in a first non-limited embodiment, the calculation of the set of encoded visually non-relevant images is achieved by computing an encoded visually relevant image from said visually relevant image and by duplicating said encoded visually relevant image so as to form the set of encoded visually non-relevant images.

In this embodiment, the calculation is very easy, very fast and does not need a complex system. Encoding of a visually non-relevant image is for instance replaced by adding a flag into the bit stream, in order to indicate that the encoded image is a copy of next visually relevant image. Consequently the bit rate cost is minimal. The human eye cannot see any difference.

Advantageously, in a second non-limited embodiment of the invention, the set of encoded visually non-relevant images is calculated using a general coarse motion compensation of said visually relevant image. In this embodiment, images of the sub set of visually non-relevant images are encoded as inter frames with respect to the subsequent visually relevant image. However, instead of performing a motion compensation for each image of the sub set of visually non-relevant images, only one general coarse motion compensation is performed for the whole sub set of visually non-relevant images. A large amount of bit rate is spared at the expense of encoded image quality, which is not an issue since the images of the sub set are visually non relevant. Said embodiment is of course more costly than the first one in terms of bit rate, but it also has the advantage of avoiding any effect of “frozen image”, which could be noticed in particular conditions of visualization of the decoded video signal like for instance slow motion.

### BRIEF DESCRIPTION OF THE DRAWINGS

Additional objects, features and advantages of the invention will become apparent upon reading the following detailed description and upon reference to the accompanying drawings in which:

FIG. 1 illustrates a video communication system comprising an encoder according to the invention,

FIG. 2 is a schematic diagram of a first encoding of a digital video signal comprising images and a scene cut, applied by the encoder of FIG. 1, and

FIG. 3 is a schematic diagram of a second encoding of a digital video signal comprising images and a scene cut, applied by the encoder of FIG. 1.

### DETAILED DESCRIPTION OF THE INVENTION

In the following description, functions or constructions well known to the person skilled in the art will not described in detail as they would obscure the invention in unnecessary detail.

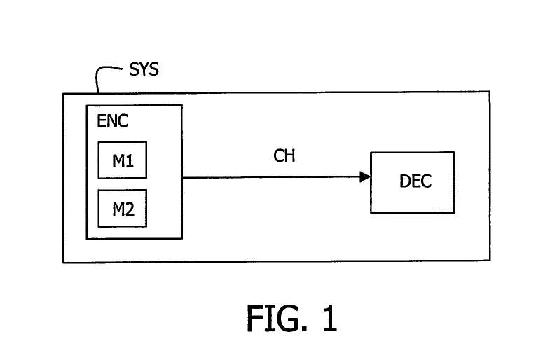

The present invention relates to a method for encoding a digital video signal, said digital video signal comprising at least a scene cut followed by a set of images. Said method is used in particular in an encoder ENC as shown in FIG. 1 within a video communication system SYS. Said system receives some digital video signals.

In order to transmit efficiently some video signals through a transmission medium CH, said encoder ENC applies an encoding along different schemes well known to the person skilled in the art: either in an intraframe model, or in an interframe one. Then the encoding signal known as bit stream is sent to a decoder DEC, which decodes said signal.

Said encoder ENC comprises:
Localization means M1 for locating said scene cuts CUT,
Definition means M2 for defining a sub set of visually non-relevant images (IS) within said set of images, and
Calculation means M3 for issuing a set (IS′) of encoded visually non-relevant images from the sub set (IS) of visually non-relevant images, said set of visually non-relevant images being calculated from a first visually relevant image (I(t0+2)) located after said scene cut CUT.

The encoding is done as follows:

In a first step 1) there is a localization of scene cuts CUT, generally with statistics codes, for indicating the place of each scene cut within the video signal. Several methods for detecting scene cuts are known to the man skilled in the art. A method based on correlations between two successive images of the video signal and disclosed in the European patent application number EP0928544 is for example used.

In addition, a flag is used to indicate if the images after said scene cut have to be coded as usual, by a DCT coding for example, or to be degraded or omitted, as described in detail hereinafter.

From this localization of the scene cut, we can distinguish between images located before and after the scene cut CUT. In the following we consider the sub set of visually non-relevant images located just after the scene cut CUT.

In a second step 2), the sub set of visually non-relevant images located just after the scene cut CUT is defined. This step 2) takes into account human eye capabilities. Indeed, perceptual studies as described in the documents “B. Girod, The information theoretical significance of spatial and temporal masking in video signals, Proc. SPIE/SPSE Conf. on Human Vision, Visual Processing and Digital Display, Los Angeles, Calif., USA, pp. 178-187, January 1989”, and “B. Girod, How important is masking for picture coding? Proc. International Picture Coding Symposium PCS '88, Torino, Italy, pp. 1.2.1-1.2.2, September 1988”, have shown that under standard viewing conditions well known to the person skilled in the art, human eyes cannot distinguish very fast changes in scenes: it is called the temporal masking effect. Therefore, the encoding is based on the idea that as human eyes cannot distinguish image details in the fraction of a second following a scene cut (human eyes need to get used for at least 1/10 of a second), this biological property may be exploited in terms of video coding: during the accommodation of the eye, all pieces of information do not need to be present in the images.

The so-called non relevant images cannot be perceived correctly by the human eye, whereas the other images are visible for the human eye. The set of visually non-relevant images (IS) comprises the visually non-relevant images, which follow the scene cut CUT. The first visually relevant image I(t0+2) is the first visually relevant image located after the scene cut CUT.

In the third step 3) of the invention, a set of encoded images (IS′) is calculated from said sub set of visually non-relevant images (IS) using the first visually relevant image located after said scene cut. In order to encode as many images as before with a much smaller number of bits, the encoding method according to the invention, encodes in a classical way, using for example DCT coding, only the visually relevant images, whereas visually non-relevant images may be degraded or omitted. The visual perceived quality remains the same.

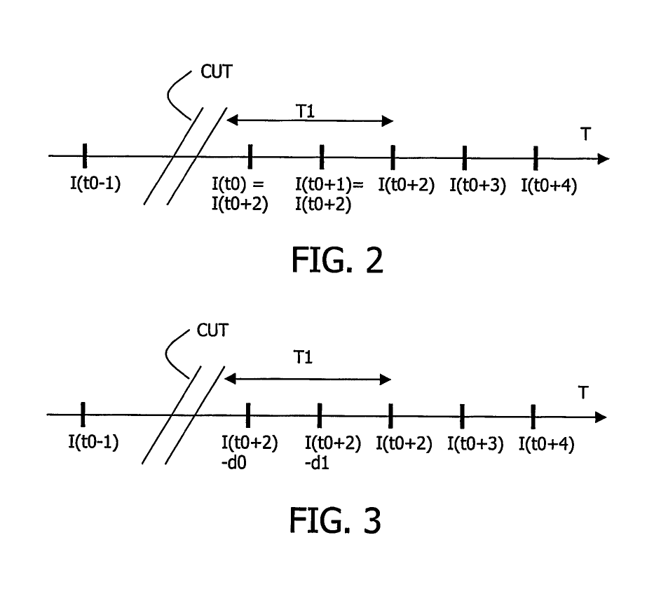

For example, as illustrated in FIG. 2, if a scene cut CUT occurs between a first image I(t0−1) and a second image I(t0), we can suppose that an image with complete details will only be distinguishable in the third image after the scene cut CUT, i.e. I(t0+2).

Hence, in a first non-limitative embodiment of the invention, the calculation C1 of the set of encoded visually non-relevant images (IS′) is done by computing an encoded visually relevant image I′(t0+2) from the visually relevant image I(t0+2) and by duplicating said encoded visually relevant image I′(t0+2) so as to form the set of encoded visually non-relevant images (IS′).

As shown in FIG. 2, the non-relevant images I(t0) and I(t0+1) become the encoded images I′(t0) and I′(t0+1) which are both identical to the encoded visually relevant image I′(to+2). In that case, the following encoding sequence I′(t0−1), I′(t0+2), I′(t0+2), I′(t0+2), I′(t0+3), I′(t0+4), etc is obtained. Successive identical images can be encoded very efficiently, that is with very few bits. Note that a simple flag may signal that an image is simply repeated from the previous image, said flag being inserted into the bit stream. Thus, in the previous example, the image I(t0−1) will be encoded, then I(t0+2), subsequently there will be 2 copy flags after which the image I(t0+3) will be coded.

Another alternative is to have a simple flag that may signal that the image is simply repeated from a following image.

In a second non-limitative embodiment of the invention, the calculation C2 of the set of encoded visually non-relevant images (IS′) is performed using a general coarse motion compensation of said visually relevant image I(t0+2), for example by means of a mesh method well known to the person skilled in the art.

Thus, as shown in FIG. 3, in the second non-limitative embodiment of the invention, a general coarse motion vector field MVF is calculated and used for all the images of the set of non-relevant images (IS) for instance with respect to the visually relevant image I(t0+2). In that case, the encoding sequence is the following: I′(t0−1), I′(t0+2)−d0, I′(t0+2)−d1, I′(t0+2), I′(t0+3), I′(t0+4), etc, with d0, d1 representing a coarse moving of the pixels between images I(t0+2) and I(t0) and I(t0+2) and I(t0+1), respectively. This set of images can be very efficiently encoded because a unique field of general coarse motion vectors has to be included into the bitstream. Note that a simple flag may signal to a decoder such a way of encoding the visually non-relevant images.

Practically, in the case of an image rate of 30 Hz, if human eyes need at least 1/10 second to accommodate, it means that only the third image will be distinguishably seen. Therefore, the quality of the two images between the scene cut CUT and this time may be cleverly degraded as proposed above.

Note that, in the case of slow motion within some sets of images in the video signal, the calculation of the visually non-relevant images, as described above in the two embodiments, can be applied to more than two images without annoying visual artifacts.

Thus, a first advantage of the present invention is to improve the rate/distortion ratio, without losing any perceptual quality, as the non-relevant information i.e. the non-distinguishable images are not encoded as usual, and consequently fewer bits are used.

The other advantages of the present invention are, on the one hand, a reduction of the time taken by the encoding, as a copy or an approximation of an image is very fast, and on the other hand, a reduction of the memory taken by the encoding process, and this without losing any perceptual quality (i.e. subjective quality) in the encoding.

It is to be understood that the present invention is not limited to the aforementioned embodiments and variations and modifications may be made without departing from the spirit and scope of the invention as defined in the appended claims. In this respect, the following closing remarks are made.

It is to be understood that the present invention is not limited to the aforementioned video application. It can be used within any application using a system for processing a digital video signal where the ultimate consumer is the human eye, such as applications including digital movies, HDTV, and transmission and visualization of scientific imagery. Image codes have to be designed to match the visual capabilities of the human observer.

It is to be understood that the method according to the present invention is not limited to the aforementioned implementation.

There are numerous ways of implementing functions of the method according to the invention by means of items of hardware or software, or both, provided that a single item of hardware or software can carry out several functions. It does not exclude that an assembly of items of hardware or software or both carry out a function, thus forming a single function without modifying the method of processing the video signal in accordance with the invention.

Said hardware or software items can be implemented in several manners, such as by means of wired electronic circuits or by means of an integrated circuit that is suitably programmed. The integrated circuit may be contained in a computer or in an encoder. In the second case, the encoder comprises localization means adapted to make the localization of a scene cut, and calculation means adapted to issue a set of images just after a scene cut, said set being calculated from a visually distinguishable image after said scene cut, as described previously, said means being hardware or software items as stated above.

The integrated circuit comprises a set of instructions. Thus, said set of instructions contained, for example, in a computer programming memory or in an encoder memory may cause the computer or the encoder to carry out the different steps of the decoding method.

The set of instructions may be loaded into the programming memory by reading a data carrier such as, for example, a disk. A service provider can also make the set of instructions available via a communication network such as, for example, the Internet.

Any reference sign in the following claims should not be construed as limiting the claim. It will be obvious that the use of the verb “to comprise” and its conjugations do not exclude the presence of any other steps or elements besides those defined in any claim. The article “a” or “an” preceding an element or step does not exclude the presence of a plurality of such elements or steps.

1. A method for encoding a digital video signal (VS), said digital video signal comprising at least a scene cut (CUT) followed by a set of images characterized in that said method comprises the steps of:
Localizing said scene cut (CUT),
Defining a sub-set of visually non-relevant images (IS) within said set of images, and
Issuing a set of encoded visually non-relevant images (IS′) from said set of visually non-relevant images (IS) by calculating said set of encoded visually non-relevant images (IS′) from a visually relevant image (I(t0+2)) located after said scene cut (CUT).

2. A method for encoding a digital video signal (VS) as claimed in claim 1, characterized in that the calculation of said set of encoded visually non-relevant images (IS′) is done by computing an encoded visually relevant image (I′(t0+2)) from said visually relevant image (I(t0+2)) and by duplicating said encoded visually relevant image (I′(t0+2)) so as to form the set of encoded visually non-relevant images (IS′).

3. A method for encoding a digital video signal (VS) as claimed in claim 1, characterized in that the set of encoded visually non-relevant images (IS′) is calculated using a general coarse motion compensation of said visually relevant image (I(t0+2)).

4. A computer program product for an encoder (ENC), comprising a set of instructions, which, when loaded into said encoder (ENC), causes the encoder (ENC) to carry out the method as claimed in claims 1 to 3.

5. A computer program product for a computer, comprising a set of instructions, which, when loaded into said computer, causes the computer to carry out the method as claimed in claims 1 to 3.

6. A video encoder (ENC) for processing a digital video signal (VS), said video signal comprising at least a scene cut (CUT) followed by a set of visually non-relevant images (IS), characterized in that it comprises:
Localization means (M1) for localizing said scene cut (CUT),
Definition means (M2) for defining a sub set of visually non-relevant images (IS) within said set of images, and
Calculation means (M3) for issuing a set of encoded visually non-relevant images (IS′) from the set of visually non-relevant images (IS), said set of encoded visually non-relevant images (IS′) being calculated from a visually relevant image (I(t0+2)) located after said scene cut (CUT).

7. A video encoder (ENC) for encoding a digital video signal (VS) as claimed in claim 6, characterized in that said calculation means (M2) issue a set of encoded visually non-relevant images (IS′) by computing an encoded visually relevant image (I′(t0+2) from said visually relevant image (I(t0+2)) and by duplicating said encoded visually relevant image (I′(t0+2) so as to form said set of encoded visually non-relevant images.

8. A video encoder for processing a digital video signal (VS) as claimed in claim 6, characterized in that said calculation means (M2) issue a set of processed images by means of a general coarse motion compensation of said visually distinguishable image (I(t0+2)).

9. A video communication system comprising a video encoder (ENC), which is able to receive a digital video signal (VS), said signal being processed by the encoder (ENC) as defined in claim 6.
